(19) United States
(12) Patent Application Publication
(10) Pub. No.: US 2016/0054852 A1
(43) Pub. Date: Feb. 25, 2016

(54) METHOD FOR ACQUIRING ACTUAL COORDINATE AND METHOD FOR DETECTING INPUT DEVICE

(71) Applicant: KOTO CO., LTD., Nakagyo-ku, Kyoto City, Kyoto (JP)

(72) Inventor: Hiroshi KIRITA, Kyoto (JP)

(21) Appl. No.: 14/831,582

(22) Filed: Aug. 20, 2015

(30) Foreign Application Priority Data
Aug. 21, 2014 (JP) 2014-181699

(51) Int. Cl. G06F 3/041; G06F 3/044

(52) U.S. Cl. CPC G06F 3/0416; G06F 3/044

(57) ABSTRACT

Correction information defined based on a tendency of adjustment made by execution of system software is stored in a memory in advance. A CPU acquires adjusted coordinates output from the system software. Moreover, the CPU acquires a display direction of an image from the system software. Then, the CPU extracts the correction information corresponding to this display direction from the memory and applies this correction information to the acquired adjustment coordinates. Thereby, actual coordinates, which are coordinates before the adjustment made by the system software, can be acquired.

### CROSS-REFERENCE TO RELATED APPLICATIONS

This application claims priority to Japanese Patent Application No. 2014-181699 filed on Aug. 21, 2014. The entire disclosures of Japanese Patent Application No. 2014-181699 are hereby incorporated herein by reference.

### BACKGROUND

1. Technical Field

The present invention relates to a method for acquiring actual coordinates of a contact portion in contact with a touch panel, and a method for detecting an input device using this actual coordinate acquisition method.

2. Related Art

There is known a terminal including a touch panel and a touch panel controller that detects coordinates of a contact portion in contact with an input surface of this touch panel. As the above-described touch panel, a typical touch panel is a capacitance-type touch panel in which the contact portion comes into contact with the input surface and thereby a capacitance changes.

There has been proposed an input device that is used while being placed on the input surface of the above-described touch panel (refer to JP-A-2012-99093 and JP-A-2012-168612). The input device includes a plurality of contact portions on a bottom surface side thereof. Each of the contact portions comes into contact with the input surface of the touch panel, and thereby coordinates are input. Each type of input device is provided with a different arrangement pattern of the contact portions. Accordingly, a plurality of input devices are distinguished from one another. That is, the terminal detects the arrangement pattern from the coordinates of the plurality of contact portions, and thereby can identify each input device and acquire specific information given to the input device.

Various types of application software using the above-described input device function on the premise that precise coordinates of the contact portions of the input device placed on the touch panel, that is, the coordinates of a position where each of the contact portions is actually in physical contact with the touch panel (hereinafter, referred to as actual coordinates) are passed on. These actual coordinates typically indicate a gravity center position of a surface in contact with the input surface of the touch panel.

On the other hand, a portable information terminal including a touch panel functions on the premise of operation of bringing a finger into contact with the touch panel. As such a portable information terminal, there is a portable information terminal having system software installed therein to optimize the finger operation. Specifically, in order to enhance usability for a user, there has been proposed adjustment of a position slightly displaced from coordinates detected by a fingertip portion in physical contact with the input surface as coordinates of the fingertip portion (JP-T-2009-509234). This adjustment is put into practical use in a smartphone or a tablet computer.

In the case where the above-described input device is used for the above-described portable information terminal having the system software installed therein to optimize the finger operation, the coordinates of the contact portions passed from the system software have been already adjusted. For this reason, there has been a problem in detection accuracy of the input device because the arrangement pattern cannot be detected based on the actual coordinates. Then, development of application software using the input device will also be hindered.

### SUMMARY

Consequently, it is an object of the present invention to provide a method for acquiring actual coordinates to precisely acquire coordinates of a contact portion of an input device or the like in a portable information terminal having system software installed therein to optimize finger operation on a touch panel, and a method for detecting the input device using the method for acquiring actual coordinates.

In order to achieve the above-described object, according to a first aspect of the present invention, there is provided a method for acquiring actual coordinates which includes the steps of:

preparing a portable information terminal that includes a touch panel and system software installed therein to detect actual coordinates of a contact portion in contact with the touch panel and output adjusted coordinates resulting from adjustment of the actual coordinates;

storing correction information defined based on a tendency of the adjustment in a memory of the portable information terminal;

acquiring the output adjusted coordinates;

extracting the correction information from the memory to apply the correction information to the acquired adjusted coordinates; and

acquiring, as the actual coordinates of the contact portion, the adjusted coordinates to which the correction information is applied.

According to a second aspect of the present invention, a recording medium in which a program is recorded and causes a computer that includes a touch panel, and system software installed therein to detect actual coordinates of a contact portion in contact with the touch panel and output adjusted coordinates resulting from adjustment of the actual coordinates, to execute:

storing correction information defined based on a tendency of the adjustment in a memory of the computer;

acquiring the output adjusted coordinates;

extracting the correction information from the memory to apply the correction information to the acquired adjusted coordinates; and

acquiring, as the actual coordinates of the contact portion, the adjusted coordinates to which the correction information is applied.

According to a third aspect of the present invention, a method for detecting an input device in which a portable information terminal includes a touch panel, and system software installed therein to detect actual coordinates of a plurality of contact portions in contact with the touch panel and output a plurality of adjusted coordinates resulting from adjustment of the respective actual coordinates, and the portable information terminal detects the input device that has the plurality of contact portions coming into contact with a touch panel and is given specific information, the method includes the steps of:

storing correction information defined based on a tendency of the adjustment in a memory of the portable information terminal;

storing an arrangement pattern of the plurality of contact portions of the input device in the memory;

acquiring the plurality of output adjusted coordinates; extracting the correction information from the memory to apply the extracted correction information to the plurality of acquired adjusted coordinates;

acquiring, as the actual coordinates of the plurality of contact portions, the plurality of adjusted coordinates to which the correction information is applied; and

reading the arrangement pattern of the plurality of contact portions from the memory to recognize the input device when the arrangement pattern of the plurality of contact portions is consistent with a positional relation of the acquired actual coordinates of the plurality of contact portions.

According to the present invention, correction information is applied to coordinates adjusted by execution of system software and thereby actual coordinates of a contact portion can be acquired in a portable information terminal having the system software installed therein to optimize finger operation on a touch panel. In this manner, since the coordinates of the contact portion can be acquired precisely, detection accuracy of an input device can be enhanced in an application using the input device. Thus, application software employed in the portable information terminal can be created easily and accurately.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a perspective view of a portable information terminal in which finger operation on a touch panel is optimized;

FIG. 2 is a block diagram of the portable information terminal illustrated in FIG. 1;

FIG. 3 is a block diagram of an external memory illustrated in FIG. 2;

FIG. 4 is an explanatory diagram showing a display screen of lengthwise display;

FIG. 5 is a view showing a graph relating to an adjustment tendency and a correction function in a lateral direction in a lengthwise display posture;

FIG. 6 is a view showing a graph relating to an adjustment tendency and a correction function in a longitudinal direction in the lengthwise display posture;

FIG. 7 is an explanatory diagram showing a display screen of sidewise display;

FIG. 8 is a view showing a graph relating to an adjustment tendency and a correction function in the lateral direction in a sidewise display posture;

FIG. 9 is a view showing a graph relating to an adjustment tendency and a correction function in the longitudinal direction in the sidewise display posture;

FIG. 10 is a perspective view showing a state where an input device is placed on an input surface of a touch panel;

FIG. 11 is a perspective view of the input device illustrated in FIG. 10;

FIG. 12 is a view showing a graph relating to an adjustment tendency and a correction function in a lateral direction in a lengthwise display posture;

FIG. 13 is a view showing a graph relating to an adjustment tendency and a correction function in a longitudinal direction in the lengthwise display posture;

FIG. 14 is a view showing a graph relating to an adjustment tendency and a correction function in the lateral direction in a sidewise display posture;

FIG. 15 is a view showing a graph relating to an adjustment tendency and a correction function in the longitudinal direction in the sidewise display posture; and

FIG. 16 is a flowchart describing an example of a detection method of the input device.

### DESCRIPTION OF EXEMPLARY EMBODIMENTS

Embodiments of the present invention will be described with reference to the drawings. Note that the same reference numerals used throughout the drawings denote the same or similar components.

### First Embodiment

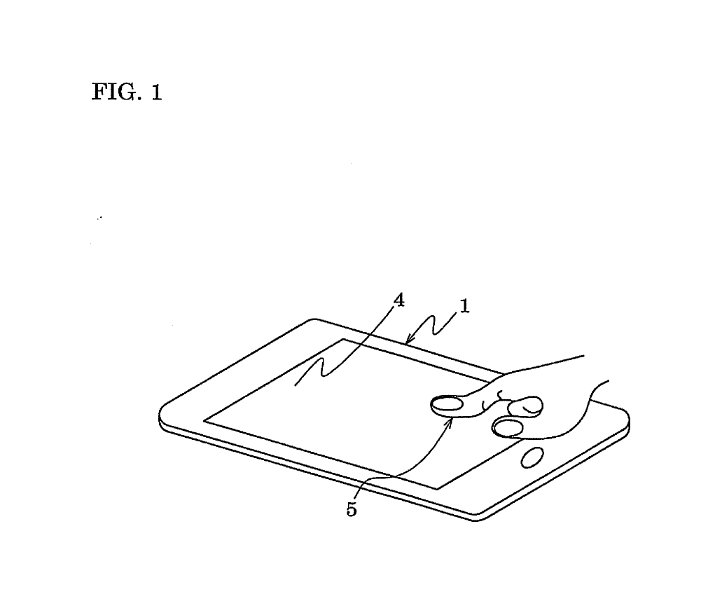

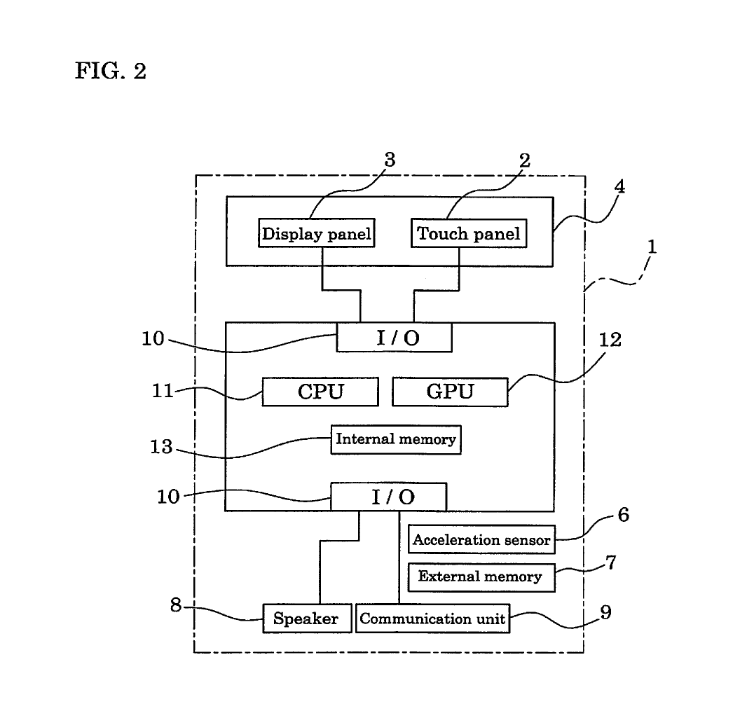

A portable information terminal 1 to be used in the present embodiment includes a panel module, as shown in FIGS. 1 and 2. A smart device such as a smartphone and a tablet terminal is typically used as the above-described portable information terminal 1. In the panel module, a touch panel 2 is layered on a display panel 3 having a rectangular display screen 4. The typical touch panel 2 is the capacitance-type touch panel 2 in which when a contact portion such as a fingertip 5 of a human comes into contact with an input surface of the touch panel 2, capacitance changes. Moreover, the touch panel 2 preferably corresponds to so-called multi-touch that can simultaneously detect a plurality of contact portions. The touch panel 2 has a resolution of 320×580.

The portable information terminal 1 is realized by means of a computer including a central processing unit (hereinafter, abbreviated to a CPU, and denoted by reference numeral 11), an internal memory 13, an external memory 7, a graphics processing unit (hereinafter, abbreviated to a GPU, and denoted by reference numeral 12), an I/O interface 10, an acceleration sensor 6, a speaker 8, and a communication unit 9 in addition to the above-described panel module. Note that a power supply unit is omitted.

The communication unit 9 constructs a Wi-Fi function, a wireless LAN function, a telephone function and a mobile communication line function, and the like. Thus, the portable information terminal 1 includes a portable communication terminal having the telephone function, a portable communication terminal having the wireless LAN function, a portable communication terminal having the telephone function, the mobile communication line function, and the wireless LAN function, and a portable communication terminal having the Wi-Fi function.

The CPU 11 loads a program stored in the external memory 7 into the internal memory 13 and executes the program. Accordingly, the CPU 11 controls the touch panel 2, the acceleration sensor 6, the speaker 8, and the communication unit 9 through the I/O interface 10 and causes the display panel 3 to display an image through the GPU 12. A semiconductor memory such as a Random Access Memory is typically used as each of these external memory 7 and internal memory 13.

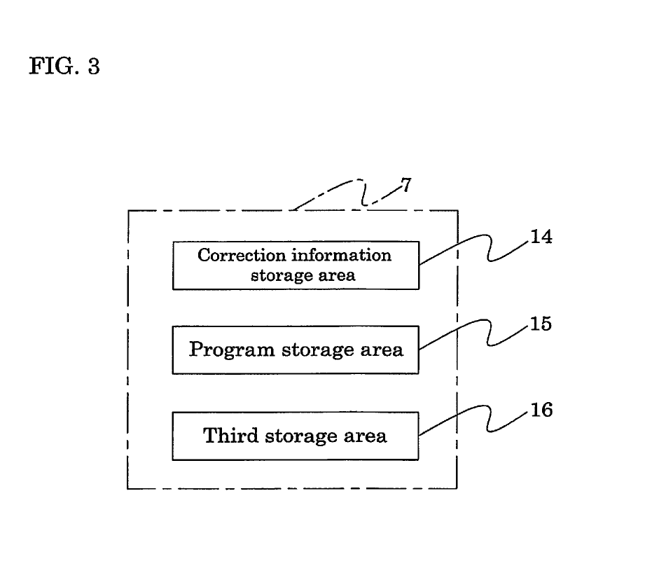

The external memory 7 is provided with a program storage area 15 and a third storage area 16, as shown in FIG. 3. The third storage area 16 is an area in which system software such as an operating system for the portable information terminal 1 is stored. The system software is executed by the CPU 11 with power supply to the portable information terminal 1. The portable information terminal 1 at the time of executing this system software detects coordinates of the contact portion, and outputs an action on these detected coordinates to the display panel 3. Moreover, the portable information terminal 1 switches a display direction of the image in the display screen 4.

The detection of a position of the contact portion by executing the system software will be described.

First, the CPU 11 of the computer acquires the coordinates of the contact portion such as the fingertip 5 actually being in contact with the touch panel 2 (hereinafter, these coordinates will be referred to as actual coordinates). The actual coordinates are typically coordinates that indicate a gravity center position of the contact portion in contact with the input surface of the touch panel 2. These actual coordinates are generated by a touch panel 2 controller that senses a change in capacitance caused in the contact portion present on the input surface of the touch panel 2, and are passed as a touch event to the CPU 11 executing the system software.

Upon acquiring the actual coordinates, the CPU 11 applies predetermined adjustment values to the actual coordinates. Accordingly, the CPU 11 generates and outputs coordinates on the touch panel 2 that a user may intend (hereinafter, these coordinates will be referred to as adjusted coordinates). That is, these adjusted coordinates are coordinates obtained by adjusting a difference between the actual coordinates and a contact position to the touch panel 2 that is indication of intention from a sight line of the user (displacing vertically and horizontally), and this adjustment is referred to as optimizing for finger operation.

In this manner, the computer executes a step of detecting the actual coordinates of the contact portion in contact with the touch panel 2 and outputting the adjusted coordinates resulting from the adjustment of the actual coordinates.

The switching of the display direction by executing the system software will be described.

First, the CPU 11 of the computer acquires a sensing signal from the acceleration sensor 6 and determines whether the display screen 4 lies sidewise or lengthwise with respect to the user. Note that lying sidewise indicates a state where the display screen 4 is held such that a longitudinal side of the display screen 4 becomes substantially horizontal. Moreover, lying lengthwise indicates a state where the display screen 4 is held such that a short side of the display screen 4 becomes substantially horizontal. This acceleration sensor 6 is a sensor that outputs the sensing signal indicating a state of the posture of the display screen 4. Typically, a triaxial sensor is used, and the triaxial sensor senses longitudinal and lateral directions of the display screen 4 and gravitational acceleration acting in a direction perpendicular to the display screen 4.

Next, the CPU 11 switches the display direction of the image in the display screen 4 through the GPU 12 in accordance with the determined result.

In this manner, the computer executes the step of switching the display direction of the image in the display screen 4 in accordance with the sensing signal output from the acceleration sensor 6.

Other various types of applications are stored in the above-described third storage area 16. Further, data generated by these applications is also stored in the third storage area 16.

Moreover, as shown in FIG. 3, the external memory 7 is provided with a correction information storage area 14. Correction information is stored in this correction information storage area 14. This correction information is used when the adjusted coordinates output from the system software are corrected. The correction information is predetermined based on a tendency of the adjustment made by the system software, and is stored in association with the posture of the display screen 4.

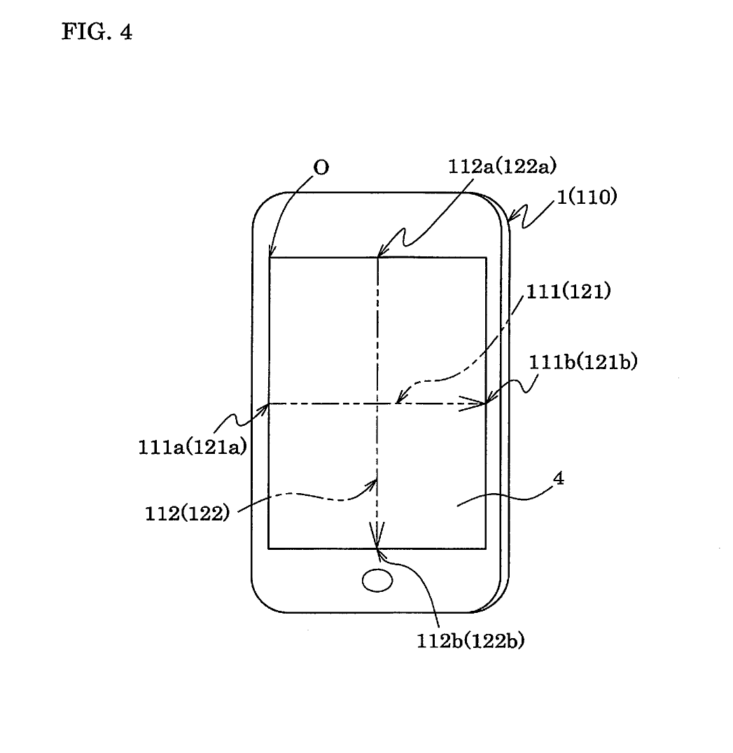

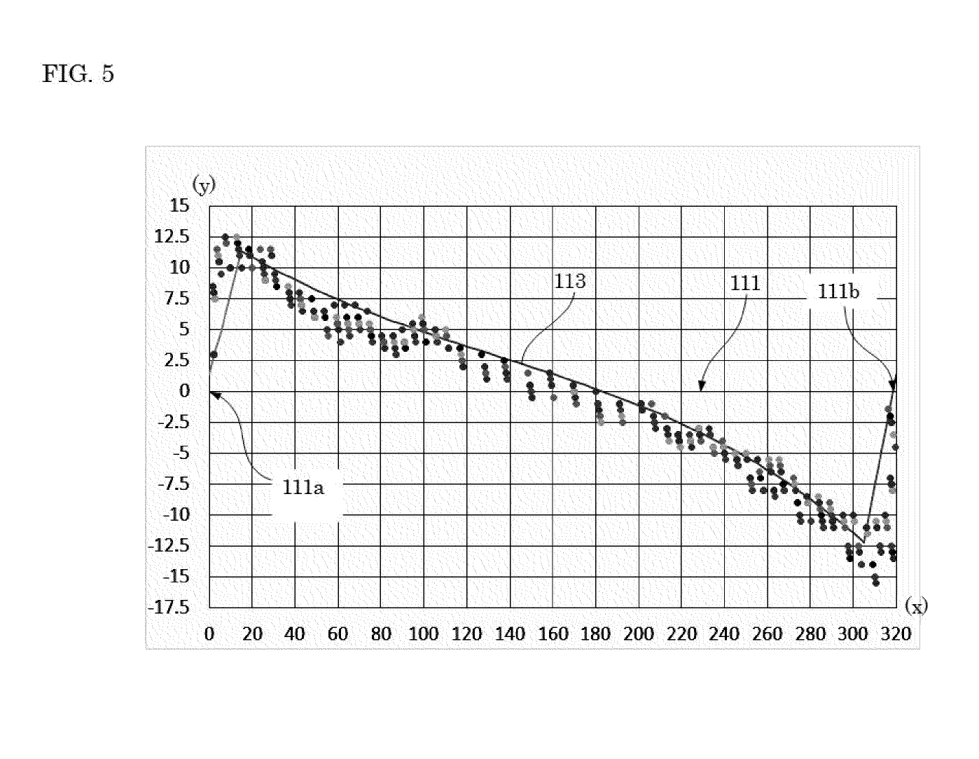

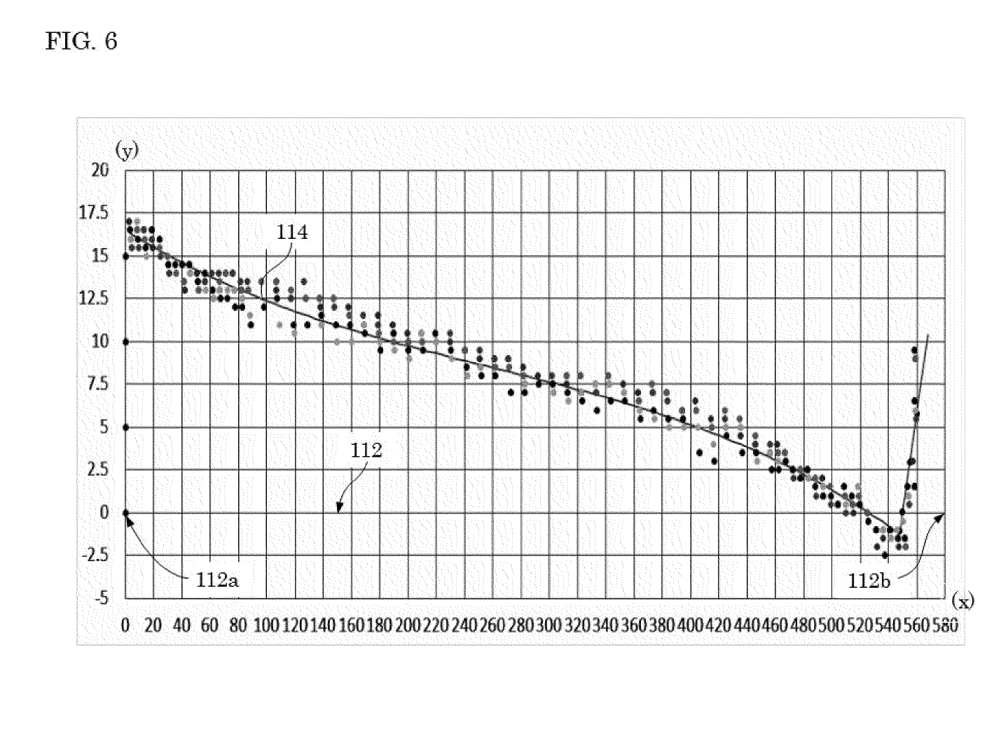

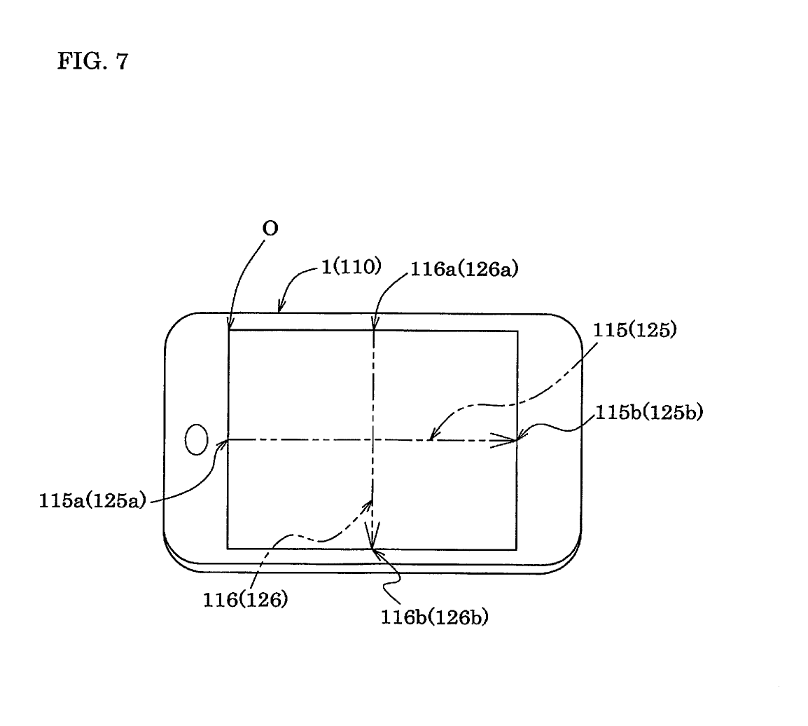

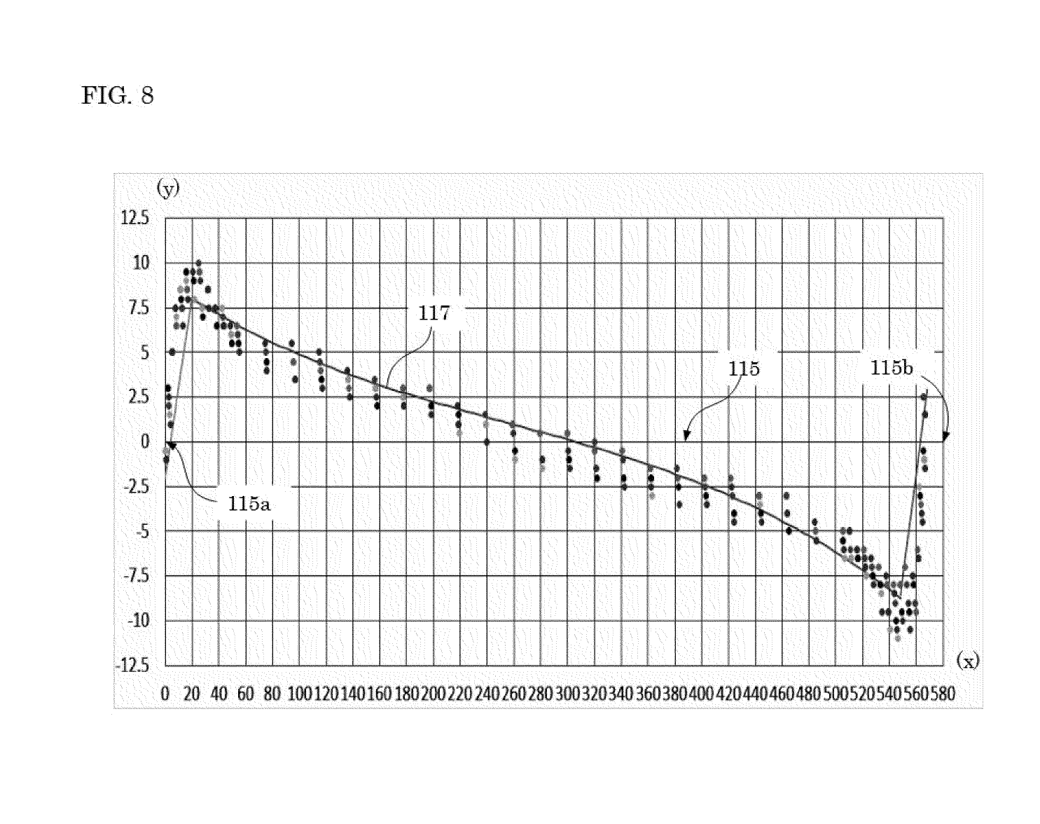

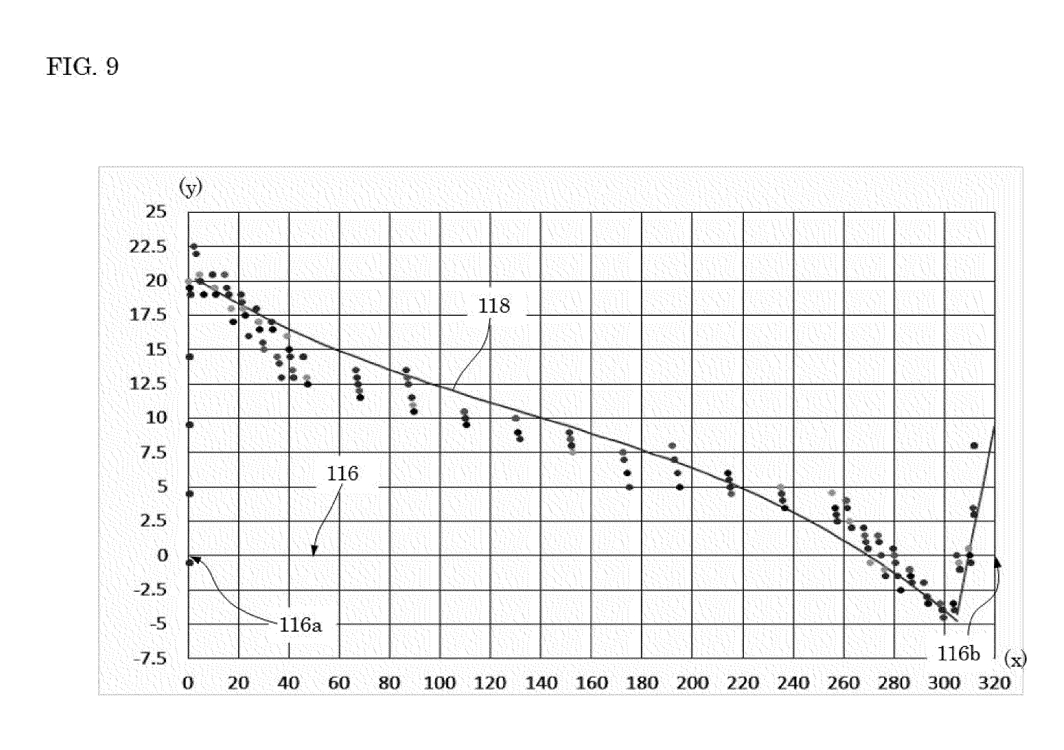

The tendency of the adjustment is found from results obtained by actual measurement (FIGS. 5, 6, 8, and 9) using a plurality of portable information terminals 1 shown in FIGS. 4 and 7. Note that each of the portable information terminals 1 has the above-described system software installed therein and the finger operation is optimized. In the actual measurement, measurement coordinates were physically defined on the touch panel, and when these measurement coordinates were touched, the adjusted coordinates output from the system software were recorded. Further, values obtained by subtracting the adjusted coordinates from these measurement coordinates (hereinafter, these values will be referred to as subtraction values) were recorded. Note that the measurement coordinates are represented by the same rectangular coordinate system as the adjusted coordinates, and an upper left portion of the display screen 4 is the origin. Actual measurement results at the time of holding the display screen 4 in a lengthwise posture (FIG. 4) with respect to the user are shown in FIGS. 5 and 6. Moreover, actual measurement results at the time of holding the display screen 4 in a sidewise posture (FIG. 7) are shown in FIGS. 8 and 9.

FIG. 5 shows a result obtained by defining a plurality of measurement coordinates on a lateral measurement line 111 shown in FIG. 4 and performing the actual measurement. This lateral measurement line 111 is a line virtually displayed from a left end 111a to a right end 111b of the display screen 4. An x axis in FIG. 5 indicates a lateral value of the adjusted coordinates recorded when each of the measurement coordinates is touched, and is graduated in the range of “0” to “320.” Note that the “0” corresponds to the left end 111a on the lateral measurement line 111, and the “320” corresponds to the right end 111b on the lateral measurement line 111. Moreover, a y axis in FIG. 5 indicates a subtraction value recorded when each of the measurement coordinates is touched (a value obtained by subtracting the lateral value of the adjusted coordinates from a lateral value of the measurement coordinates). A + side of the y axis indicates that the adjusted coordinates are adjusted to a left side of the measurement coordinates, that is, the system software has made leftward adjustment. Moreover, a − side of the y axis indicates that the adjusted coordinates are adjusted to a right side of the measurement coordinates, that is, the system software has made rightward adjustment. Note that a plurality of points are displayed lining up lengthwise for each point on the x axis, which indicates variation at the time of actually measuring the plurality of portable information terminals 1. In this manner, a tendency of adjustment in a lateral direction made by the system software can be found from an assembly of the points shown in FIG. 5. Then, linear approximation is obtained by a minimum square method, based on the above-described assembly of the points, and is represented in FIG. 5 as a graph 113 indicating a correction function in the lateral direction in a lengthwise display posture.

The correction function indicated by the graph 113 shown in FIG. 5 is specifically as follows:

The correction function includes f₁(x)=0.6637x+0.9 in the range of 0≦x<15.

Moreover, the correction function includes f₂(x)=−1.12×10⁻⁷x³+4.5×10⁻⁴x²−1.158×10⁻¹x+125 in the range of 15≦x≦305.

Further, the correction function includes f₃(x)=0.9093x−290.1 in the range of 305<x≦320.

In this manner, the correction function is defined for each predetermined range. Thus, the correction functions in the lateral direction in the lengthwise display posture are stored in the correction information storage area 14 in association with the areas.

FIG. 6 shows a result obtained by defining a plurality of measurement coordinates on a longitudinal measurement line 112 shown in FIG. 4 and performing the actual measurement. This longitudinal measurement line 112 is a line virtually displayed from an upper end 112a to a lower end 112b of the display screen 4. An x axis in FIG. 6 indicates a longitudinal value of the adjusted coordinates recorded when each of the measurement coordinates is touched, and is graduated in the range of “0” to “580.” Note that the “0” corresponds to the upper end 112a on the longitudinal measurement line 112, and the “580” corresponds to the lower end 112b on the longitudinal measurement line 112. Moreover, a y axis in FIG. 6 indicates a subtraction value recorded when each of the measurement coordinates is touched (a value obtained by subtracting the longitudinal value of the adjusted coordinates from a longitudinal value of the measurement coordinates). A + side of the y axis indicates that the adjusted coordinates are adjusted to an upper side of the measurement coordinates, that is, the system software has made upward adjustment. Moreover, a − side of the y axis indicates that the adjusted coordinates are adjusted to a lower side of the measurement coordinates, that is, the system software has made downward adjustment. Note that a plurality of points are displayed lining up lengthwise for each point on the x axis, which indicates variation at the time of actually measuring the plurality of portable information terminals 1. In this manner, a tendency of adjustment in a longitudinal direction made by the system software can be found from an assembly of the points shown in FIG. 6. Then, linear approximation is obtained by the least squares method, based on the above-described assembly of the points, and is represented in FIG. 6 as a graph 114 indicating a correction function in the longitudinal direction in the lengthwise display posture.

The correction function indicated in the graph 114 shown in FIG. 6 is specifically as follows:

The correction function includes f₄(x)=−1.55×10⁻⁷x³+1.2×10⁻⁴x²−5.16×10⁻¹x+16.5 in the range of 3≦x≦548.

Moreover, the correction function includes f₅(x)=0.5725x−314.8 in the range of 548<x≦568.

In this manner, the correction function is defined for each predetermined range. Thus, the correction functions in the longitudinal direction in the lengthwise display posture are stored in the correction information storage area 14 in association with the areas. Note that in the posture of the display screen 4 shown in FIG. 4, it was impossible to acquire the adjusted coordinates in the ranges of 0≦x<3 and 568<x≦580.

FIG. 8 shows a result obtained by defining a plurality of measurement coordinates on a lateral measurement line 115 shown in FIG. 7 and performing the actual measurement. This lateral measurement line 115 is a line virtually displayed from a left end 115a to a right end 115b of the display screen 4. An x axis in FIG. 8 indicates a lateral value of the adjusted coordinates recorded when each of the measurement coordinates is touched, and is graduated in the range of “0” to “580.” Note that the “0” corresponds to the left end 115a on the lateral measurement line 115, and the “580” corresponds to the right end 115b on the lateral measurement line 115. Moreover, a y axis in FIG. 8 indicates a subtraction value recorded when each of the measurement coordinates is touched (a value obtained by subtracting the lateral value of the adjusted coordinates from a lateral value of the measurement coordinates). A + side of the y axis indicates that the adjusted coordinates are adjusted to a left side of the measurement coordinates, that is, the system software has made leftward adjustment. Moreover, a − side of the y axis indicates that the adjusted coordinates are adjusted to a right side of the measurement coordinates, that is, the system software has made rightward adjustment. A plurality of points are displayed lining up lengthwise for each point on the x axis, which indicates variation at the time of actually measuring the plurality of portable information terminals 1. In this manner, a tendency of adjustment in the lateral direction made by the system software can be found from an assembly of the points shown in FIG. 8. Then, linear approximation is obtained by the least squares method, based on the above-described assembly of the points, and is represented in FIG. 8 as a graph 117 indicating a correction function in the lateral direction in a sidewise display posture.

The correction function indicated in the graph 117 shown in FIG. 8 is specifically as follows:

The correction function includes f₆(x)=0.501x−2.01 in the range of 0≦x<20.

Moreover, the correction function includes f₇(x)=−1.55×10⁻⁷x³+1.2×10⁻⁴x²−5.16×10⁻¹x+9 in the range of 20≦x≦548.

Further, the correction function includes f₈(x)=0.5725x−322.3 in the range of 548<x≦568.

In this manner, the correction function is defined for each predetermined range. Thus, the correction functions in the longitudinal direction in the sidewise display posture are stored in the correction information storage area 14 in association with the areas. Note that in the posture of the display screen 4 shown in FIG. 7, it was impossible to acquire the adjusted coordinates in the range of 568<x≦580.

FIG. 9 shows a result obtained by defining a plurality of measurement coordinates on a longitudinal measurement line 116 shown in FIG. 7 and performing the actual measurement. This longitudinal measurement line 116 is a line virtually displayed from an upper end 116a to a lower end 116b of the display screen 4. An x axis in FIG. 9 indicates a longitudinal value of the adjusted coordinates recorded when each of the measurement coordinates is touched, and is graduated in the range of “0” to “320.” Note that the “0” corresponds to the upper end 116a on the longitudinal measurement line 116, and the “320” corresponds to the lower end 116b on the longitudinal measurement line 116. Moreover, a y axis in FIG. 9 indicates a subtraction value recorded when each of the measurement coordinates is touched (a value obtained by subtracting the longitudinal value of the adjusted coordinates from a longitudinal value of the measurement coordinates). A + side of the y axis indicates that the adjusted coordinates are adjusted to an upper side of the measurement coordinates, that is, the system software has made upward adjustment. Moreover, a − side of the y axis indicates that the adjusted coordinates are adjusted to a lower side of the measurement coordinates, that is, the system software has made downward adjustment. Note that a plurality of points are displayed lining up lengthwise for each point on the x axis, which indicates variation at the time of actually measuring the plurality of portable information terminals 1. In this manner, a tendency of adjustment in the longitudinal direction made by the system software can be found from an assembly of the points shown in FIG. 9. Then, linear approximation is obtained by the least squares method, based on the above-described assembly of the points, and is represented in FIG. 9 as a graph 118 indicating a correction function in the longitudinal direction in the sidewise display posture.

The correction function indicated in the graph 118 shown in FIG. 9 includes f₉(x) and f₁₀(x). The correction function is specifically as follows:

The correction function includes f₉(x)=−1.12×10⁻⁷x³+4.5×10⁻⁴x²−1.158×10⁻¹x+21 in the range of 3≦x≦305. Moreover, the correction function 118 includes f₁₀(x)=0.9093x−281.6 in the range of 305<x≦320.

In this manner, the correction function is defined for each predetermined range. Thus, the correction functions in the longitudinal direction in the sidewise display posture are stored in the correction information storage area 14 in association with the areas. Note that in the posture of the display screen 4 shown in FIG. 7, it was impossible to acquire the adjusted coordinates in the range of 0≦x<3.

As shown in FIG. 3, the external memory 7 is provided with the program storage area 15. This program storage area 15 is an area in which an actual coordinate acquisition program according to the present embodiment is stored. Each of the portable information terminals 1 at the time of executing this actual coordinate acquisition program executes an adjusted coordinate acquisition step and a correction step.

The adjusted coordinate acquisition step is a step in which the CPU 11 of the computer acquires the adjusted coordinates. These adjusted coordinates are coordinates resulting from the actual coordinates adjusted by executing the system software as described above. The adjusted coordinates can be acquired from the system software, for example, as the touch event.

The correction step includes an extraction step and an application step. In the extraction step, first, the CPU 11 acquires the sensing signal from the acceleration sensor 6. Upon acquiring the sensing signal, the CPU 11 determines the posture of the display screen 4, based on the sensing signal. Upon determining the posture, the CPU 11 extracts the correction information corresponding to the posture from the correction information storage area 14. The application step is a step in which the CPU 11 applies the correction information extracted in the extraction step to the adjusted coordinates. In this application step, the adjusted coordinates to which the correction information is applied are acquired as the actual coordinates of the contact portion.

With reference to a display aspect in FIG. 4, a specific example in which the actual coordinates are acquired will be described. Note that as described above, the system software is executed, and thereby the image is displayed corresponding to the lengthwise posture and the adjusted coordinates of the contact portion in contact with the touch panel 2 are output.

(1) The adjusted coordinate acquisition step is executed, and thereby the adjusted coordinates, for example, (the lateral value, the longitudinal value)=(60, 200) are acquired by the touch event. These adjusted coordinates (60, 200) correspond to a position “60” on the lateral measurement line and a position “200” on the longitudinal measurement line in FIG. 4.

(2) Next, the extraction step is executed, and thereby the sensing signal output from the acceleration sensor 6 is acquired. This sensing signal includes a direction of gravitational acceleration with respect to the display screen 4. This sensing signal is analyzed to determine the lengthwise display. Then, the correction function f₂(x) in the lateral direction corresponding to the lateral value “60” of the adjusted coordinates, and the correction function f₄(x) in the longitudinal direction corresponding to the longitudinal value “200” of the adjusted coordinates are extracted from the correction functions f₁(x) to f₅(x) stored as the lengthwise display.

(3) Next, the application step is executed. Specifically, the values of the adjusted coordinates are substituted to the correction functions. Accordingly, f₂(60)=+7.5 is obtained, and f₄(200)=+10 is obtained. These derives the fact that the adjusted coordinates (60, 200) result from adjustment leftward by about “7.5” and upward by about “10” made by the system software. Back calculation of the adjustment made in this manner is performed to acquire the actual coordinates of the contact portion. That is, the lateral value of the actual coordinates indicates a position moved rightward by about “7.5” from the lateral value “60” of the adjusted coordinates. Moreover, the longitudinal value of the actual coordinates indicates a position moved downward by about “10” from the longitudinal value “200” of the adjusted coordinates. That is, approximate coordinates (67.5, 210) that approximate the actual coordinates are obtained, and these approximate coordinates are regarded and used as the actual coordinates.

Next, with reference to a display aspect in FIG. 7, a specific example in which the actual coordinates are acquired will be described. Note that as described above, the system software is executed, and thereby the image is displayed corresponding to the sidewise posture and the adjusted coordinates of the contact portion in contact with the touch panel 2 are output.

(1) The adjusted coordinate acquisition step is executed, and thereby the adjusted coordinates, for example, (the lateral value, the longitudinal value)=(400, 270) are acquired by the touch event. These adjusted coordinates (400, 270) correspond to a position “400” on the lateral measurement line and a position “270” on the longitudinal measurement line in FIG. 7.

(2) Next, the extraction step is executed, and thereby the sensing signal output from the acceleration sensor 6 is acquired. This sensing signal includes the direction of the gravitational acceleration with respect to the display screen 4. This sensing signal is analyze to determine the sidewise display. Then, the correction function f₇(x) in the lateral direction corresponding to the lateral value “400” of the adjusted coordinates, and the correction function f₉(x) in the longitudinal direction corresponding to the longitudinal value “270” of the adjusted coordinates are extracted from the correction functions f₆(x) to f₁₀(x) stored as the sidewise display.

(3) Next, the application step is executed. Specifically, the values of the adjusted coordinates are substituted to the correction functions. Accordingly, f₇(400)=−2.5 is obtained, and f₉(270)=0 is obtained. These derives the fact that the adjusted coordinates (400, 270) result from adjustment rightward by about “2.5” and upward by about “0” made by the system software. Back calculation of the adjustment made in this manner is performed to acquire the actual coordinates of the contact portion. That is, the lateral value of the actual coordinates indicates a position moved leftward by about “2.5” from the lateral value “400” of the adjusted coordinates. Moreover, the longitudinal value of the actual coordinates indicates a position moved downward by about “0” from the longitudinal value “270” of the adjusted coordinates. That is, approximate coordinates (397.5, 270) that approximate the actual coordinates are obtained, and these approximate coordinates are regarded and used as the actual coordinates.

In this manner, in the portable information terminals 1 that have the system software installed therein to optimize the finger operation, the correction information is stored, and the adjusted coordinate acquisition step and the correction step are executed, and thereby the actual coordinates, which are coordinates of the position where the contact portion is actually in contact, can be acquired. Thus, in the case of input without using the finger operation such as input using an input device, the coordinates of a contact portion of this input device can be precisely acquired. That is, detection accuracy of the input device can be enhanced.

### Second Embodiment

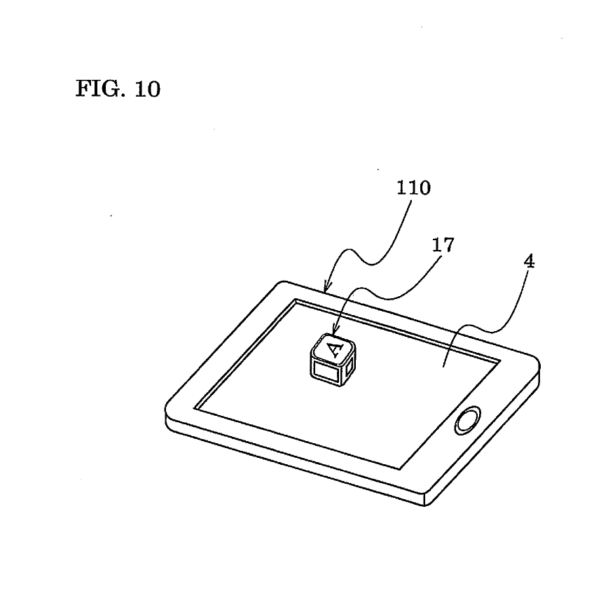

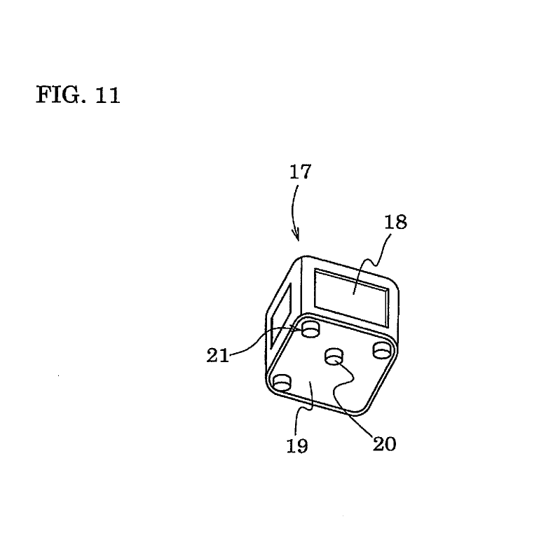

As shown in FIGS. 10 and 11, an input device 17 has a contact portion and a holding portion. The contact portion and the holding portion have conductivity, and are conducted with each other. For instance, the input device 17 has a dice shape, and has side surfaces 18 and a bottom surface 19. These side surfaces 18 and bottom surface 19 have conductivity, and are conducted with each other. In the bottom surface 19, a plurality of contactors 21 are projected. Apical surfaces 20 of these contactors 21 have conductivity, and are conducted with the bottom surface 19. For this reason, when a user grabs the side surfaces 18 with a hand, the user and the apical surfaces 20 of the contactors 21 are conducted through the side surfaces 18 and the bottom surface 19. That is, when placed on a touch panel′2 of a portable information terminal 110, the apical surfaces 20 of the contactors 21 come into contact with the touch panel 2 to function as contact portions causing change of capacitance in the touch panel 2. Further, the side surfaces 18 each function as a holding portion held by the user. Note that this input device 17 preferably has a size allowing a child to easily hold the input device 17 with one hand.

For example, an alphabet “A” is displayed on an upper surface of one of input devices 17 as described above. For example, an alphabet “B” is displayed on an upper surface of some another input device 17 as described above. In this manner, each input device 17 is given a specific display (hereinafter, referred to as specific information). Each input device 17 has a different arrangement pattern of the contact portions.

A portable information terminal used in the present embodiment (hereinafter, referred to as a second portable information terminal 110) is a terminal obtained by improving the portable information terminal 1 of the above-described first embodiment (hereinafter, referred to as a first portable information terminal 1), and both the terminals are given different model numbers from each other. Configurations of hardware of both the terminals are substantially similar. The touch panel to be used in the second portable information terminal 110 has a resolution of 320×480. In addition to correction information stored in the first portable information terminal 1 (hereinafter, referred to as first correction information), correction information defined for the second portable information terminal 110 (hereinafter, referred to as second correction information) is stored in a correction information storage area 14 of this second portable information terminal 110. The first correction information and the second correction information are associated with the above-described model numbers. For this reason, the first correction information and the second correction information is differentiated and stored. Moreover, the arrangement pattern of the contact portions of each input device 17 is stored in an external memory 7 in association with the specific information of each input device 17. This arrangement pattern defines a relative positional relation of the respective contact portions that the input device 17 has.

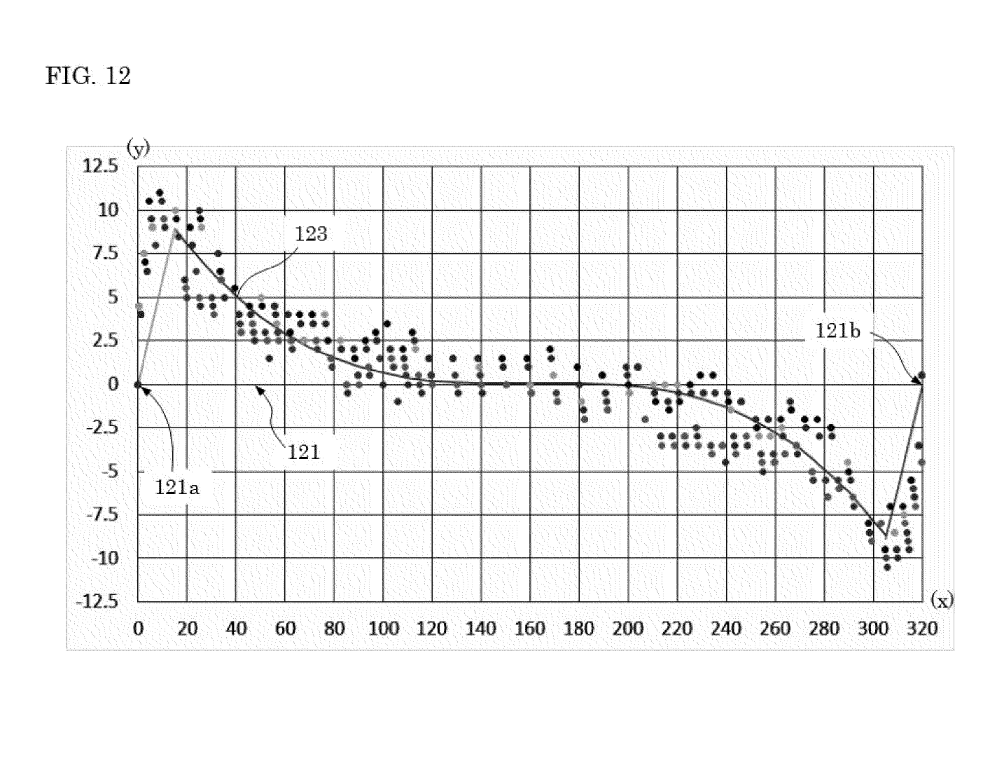

The second correction information will be described. As with the first correction information, the second correction information is defined in advance, based on a tendency of adjustment made by system software installed in the second portable information terminal 110, and is stored in association with a posture of a display screen 4. This tendency of the adjustment is found from results obtained by actual measurement using a plurality of the second portable information terminals 110 in display postures similar to those in FIGS. 4 and 7 (FIGS. 12, 13, 14, and 15).

FIG. 12 shows a result obtained by defining a plurality of measurement coordinates on a lateral measurement line 121 (FIG. 4) of the lengthwise display screen 4 and performing the actual measurement. An x axis in FIG. 12 indicates a lateral value of adjusted coordinates recorded when each of the measurement coordinates is touched, and is graduated in the range of “0” to “320.” Note that the “0” corresponds to a left end 121a on the lateral measurement line 121, and the “320” corresponds to a right end 121b on the lateral measurement line 121. Moreover, a y axis in FIG. 12 indicates a subtraction value recorded when each of the measurement coordinates is touched (a value obtained by subtracting the lateral value of the adjusted coordinates from a lateral value of the measurement coordinates). A + side of the y axis indicates that the adjusted coordinates are adjusted to a left side of the measurement coordinates, that is, the system software has made leftward adjustment. Moreover, a − side of the y axis indicates that the adjusted coordinates are adjusted to a right side of the measurement coordinates, that is, the system software has made rightward adjustment. Note that a plurality of points are displayed lining up lengthwise for each point on the x axis, which indicates variation at the time of actually measuring the plurality of second portable information terminals 110. In this manner, a tendency of adjustment in a lateral direction made by the system software of the second portable information terminal 110 can be found from an assembly of the points shown in FIG. 12. Then, linear approximation is obtained by a least squares method, based on the above-described assembly of the points, and is represented in FIG. 12 as a graph 123 indicating a correction function in the lateral direction in a lengthwise display posture.

The correction function indicated by the graph 123 shown in FIG. 12 is specifically as follows:

The correction function includes f₁₁(x)=0.5907x+0.0663 in the range of 0≦x<15.

Moreover, the correction function includes f₁₂(x)=−2.939×10⁻⁶x³+1.413×10⁻³x²−2.255×10⁻¹x+12 in the range of 15≦x≦305.

Further, the correction function includes f₁₃(x)=0.5839x−186.9 in the range of 305<x≦320.

In this manner, the correction function is defined for each predetermined range. Thus, the correction functions in the lateral direction in the lengthwise display posture are stored in the correction information storage area 14 in association with the areas.

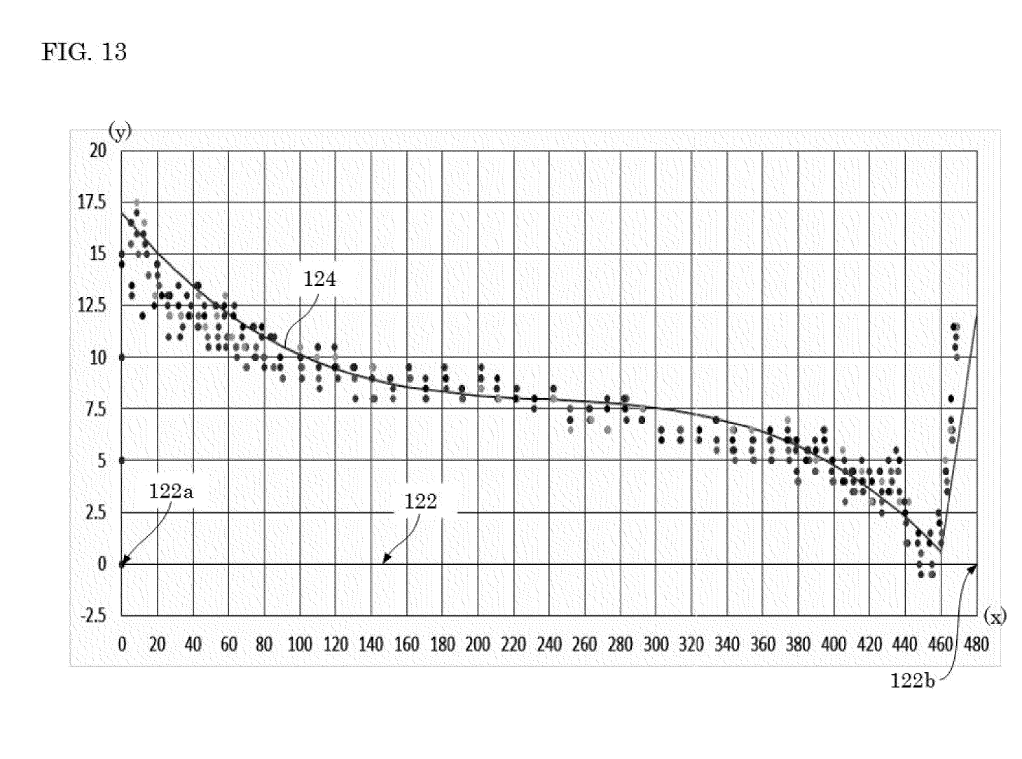

FIG. 13 shows a result obtained by defining a plurality of measurement coordinates on a longitudinal measurement line 122 (FIG. 4) of the lengthwise display screen 4 and performing the actual measurement. An x axis in FIG. 13 indicates a longitudinal value of the adjusted coordinates recorded when each of the measurement coordinates is touched, and is graduated in the range of “0” to “480.” Note that the “0” corresponds to an upper end 122a on the longitudinal measurement line 122, and the “480” corresponds to a lower end 122b on the longitudinal measurement line 122. Moreover, a y axis in FIG. 13 indicates a subtraction value recorded when each of the measurement coordinates is touched (a value obtained by subtracting the longitudinal value of the adjusted coordinates from a longitudinal value of the measurement coordinates). A + side of the y axis indicates that the adjusted coordinates are adjusted to an upper side of the measurement coordinates, that is, the system software has made upward adjustment. Moreover, a − side of the y axis indicates that the adjusted coordinates are adjusted to a lower side of the measurement coordinates, that is, the system software has made downward adjustment. Note that a plurality of points are displayed lining up lengthwise for each point on the x axis, which indicates variation at the time of actually measuring a plurality of second portable information terminals 110. In this manner, a tendency of adjustment in a longitudinal direction made by the system software of the second portable information terminal 110 can be found from an assembly of the points shown in FIG. 13. Then, linear approximation is obtained by the least squares method, based on the above-described assembly of the points, and is represented in FIG. 13 as a graph 124 indicating a correction function in the longitudinal direction in the lengthwise display posture.

The graph 124 shown in FIG. 13 includes f₁₄(x) and f₁₅(x). The graph 124 is specifically as follows:

The graph 124 includes f₁₄(x)=−5.905×10⁻⁷x³+4.225×10⁻⁴x²−1.051×10⁻¹x+17 in the range of 3≦x≦460.

The graph 124 includes f₁₅(x)=0.5747x−263.8 in the range of 460<x≦480.

In this manner, the correction function is defined for each predetermined range. Thus, the correction functions in the longitudinal direction in the lengthwise display posture are stored in the correction information storage area 14 in association with the areas. Note that in the posture of the display screen 4 shown in FIG. 4, it was impossible to acquire the adjusted coordinates in the range of 0≦x<3.

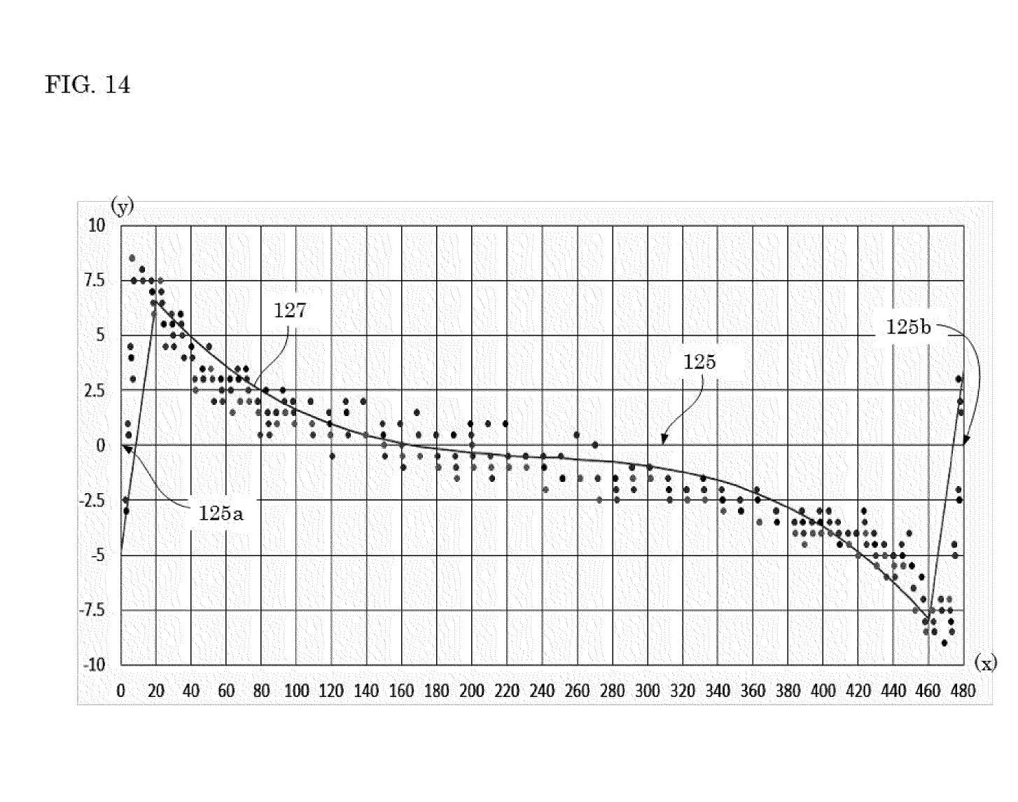

FIG. 14 is a result obtained by defining a plurality of measurement coordinates on a lateral measurement line 125 (FIG. 7) of the sidewise display screen 4 and performing the actual measurement. An x axis in FIG. 14 indicates a lateral value of the adjusted coordinates recorded when each of the measurement coordinates is touched, and is graduated in the range of “0” to “480”. Note that the “0” corresponds to a left end 125a on the lateral measurement line 125, and the “480” corresponds to a right end 125b on the lateral measurement line 125. Moreover, a y axis in FIG. 14 indicates a subtraction value recorded when each of the measurement coordinates is touched (a value obtained by subtracting the lateral value of the adjusted coordinates from a lateral value of the measurement coordinates). A + side of the y axis indicates that the adjusted coordinates are adjusted to a left side of the measurement coordinates, that is, the system software has made leftward adjustment. Moreover, a − side of the y axis indicates that the adjusted coordinates are adjusted to a right side of the measurement coordinates, that is, the system software has made rightward adjustment. Note that a plurality of points are displayed lining up lengthwise for each point on the x axis and this indicates variation at the time of actually measuring the plurality of the second portable information terminals 110. In this manner, a tendency of adjustment in the lateral direction made by the system software of the second portable information terminal 110 can be found from an assembly of the points shown in FIG. 14. Then, linear approximation is obtained by the least squares method, based on the above-described assembly of the points, and is represented in FIG. 14 as a graph 127 indicating a correction function in the lateral direction in a sidewise display posture.

The graph 127 shown in FIG. 14 includes f₁₆(x), f₁₇(x), and f₁₈(x). The graph 127 is specifically as follows:

The graph 127 includes f₁₆(x)=0.5704x−4.84 in the range of 0≦x<20.

The graph 127 includes f₁₇(x)=−5.905×10⁻⁷x³+4.225×10⁻⁴x²−1.051×10⁻¹x+8.5 in the range of 20≦x≦460.

The graph 127 includes f₁₈(x)=0.5747x−272.3 in the range of 460<x≦480.

In this manner, the correction function is defined for each predetermined range. Thus, the correction functions in the longitudinal direction in the sidewise display posture are stored in the correction information storage area 14 in association with the areas.

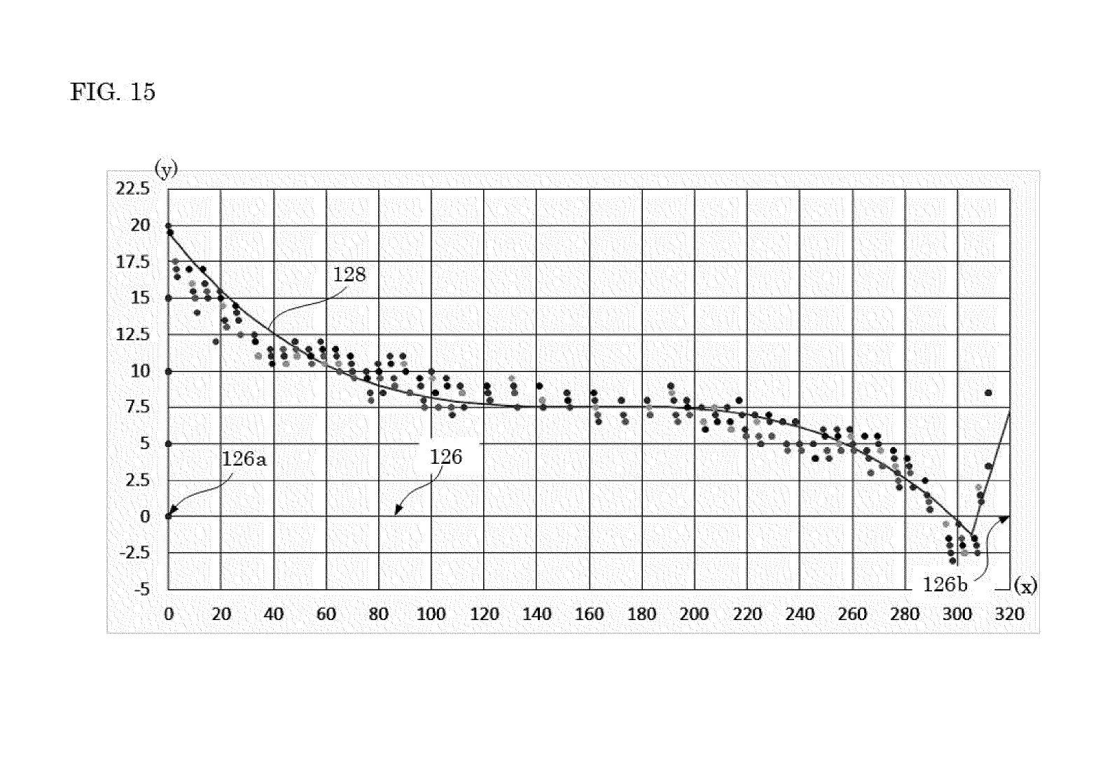

FIG. 15 shows a result obtained by defining a plurality of measurement coordinates on a longitudinal measurement line 126 (FIG. 7) of the sidewise display screen 4 and performing the actual measurement. An x axis in FIG. 15 indicates a longitudinal value of the adjusted coordinates recorded when each of the measurement coordinates is touched, and is graduated in the range of “0” to “320.” Note that the “0” corresponds to an upper end 126a on the longitudinal measurement line 126, and the “320” corresponds to a lower end 126b on the longitudinal measurement line 126. Moreover, a y axis in FIG. 15 indicates a subtraction value recorded when each of the measurement coordinates is touched (a value obtained by subtracting the longitudinal value of the adjusted coordinates from a longitudinal value of the measurement coordinates). A + side of the y axis indicates that the adjusted coordinates are adjusted to an upper side of the measurement coordinates, that is, the system software has made upward adjustment. Moreover, a − side of the y axis indicates that the adjusted coordinates are adjusted to a lower side of the measurement coordinates, that is, the system software has made downward adjustment. Note that a plurality of points are displayed lining up lengthwise for each point on the x axis and this indicates variation at the time of actually measuring the plurality of the second portable information terminals 110. In this manner, a tendency of adjustment in the longitudinal direction made by the system software of the second portable information terminal 110 can be found from an assembly of the points shown in FIG. 15. Then, linear approximation is obtained by the least squares method, based on the above-described assembly of the points, and is represented in FIG. 15 as a graph 128 indicating a correction function in the longitudinal direction in the sidewise display posture.

The graph 128 shown in FIG. 15 includes f₁₉(x) and f₂₀(x).

The graph 128 is specifically as follows:

The correction function includes f₁₉(x)=−2.939×10⁻⁶x³+1.413×10⁻³x²−2.255×10⁻¹x+19.5 in the range of 5≦x≦305.

The graph 128 includes f₂₀(x)=0.5839x−179.4 in the range of 305<x≦320.

In this manner, the correction function is defined for each predetermined range. Thus, the correction functions in the longitudinal direction in the sidewise display posture are stored in the correction information storage area 14 in association with the areas. Note that in the posture of the display screen 4 shown in FIG. 7, it was impossible to acquire the adjusted coordinates in the range of 0≦x<5.

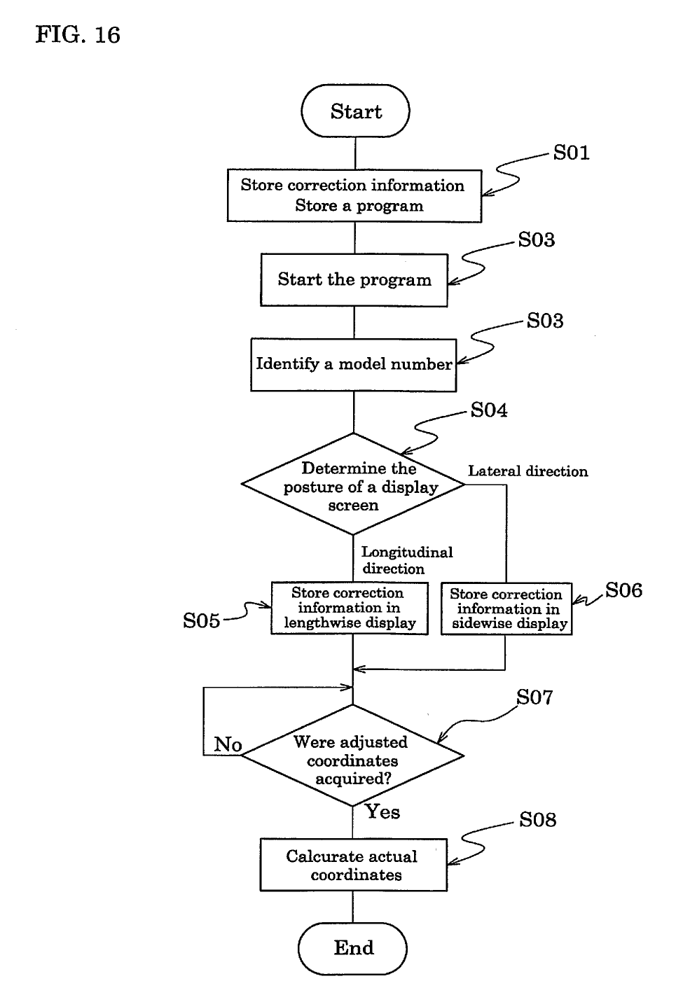

Next, a detection method of the input device 17 will be described with reference to FIG. 16.

First, the first correction information and the second correction information are stored in the correction information storage area 14. Moreover, an input device detection program including an actual coordinate acquisition program according to the present embodiment is installed and stored in a program storage area 15 (step s01).

The input device detection program is loaded on an internal memory 13 and is executed (step s02), and thereby the second portable information terminal 110 executes the following operation: A CPU 11 of a computer identifies a model number of the second portable information terminal 110 (step s03). Next, the CPU 11 acquires a sensing signal from an acceleration sensor 6 and determines the posture of the display screen 4, based on the acquired sensing signal (step s04). Then, the correction information corresponding to the identified model number and the determined posture is extracted (stored in the internal memory 13) (steps s05 and s06). Note that the above-described steps s03 to s06 are referred to as an extraction step in the present embodiment.

Next, the CPU 11 acquires the adjusted coordinates output by the execution of the system software (step s07). When the CPU 11 cannot acquire the adjusted coordinates, this step is repeated. Note that these adjusted coordinates are coordinates generated such that a touch panel 2 controller generates coordinates of the contact portions in contact with an input surface of the touch panel 2 and these coordinates are adjusted. Upon acquiring the adjusted coordinates, the CPU 11 applies the extracted correction information to the adjusted coordinates and thereby acquires actual coordinates (step s08). That is, the adjusted coordinates are substituted to the corresponding correction functions and thereby arithmetic operation used in the adjustment is derived. Back calculation of this adjustment is performed, and thereby approximate coordinates that approximate the actual coordinates are obtained. These approximate coordinates are regarded and used as the actual coordinates. Note that since the input device 17 has the plurality of contact portions, a plurality of the actual coordinates are obtained.

Next, the CPU 11 of the computer detects a positional relation of the acquired respective actual coordinates. Then, the positional relation of the detected actual coordinates is compared with the stored arrangement pattern of the contact portions. When the positional relation of the actual coordinates matches the arrangement pattern, this is determined as the input device 17. Then, the specific information (e.g., “A”) associated with this arrangement pattern can be extracted. In this manner, since the input device 17 can be detected based on the actual coordinates, detection accuracy of the input device can be enhanced. Then, downsizing of the input device can be realized. Moreover, more arrangement patterns can be provided, and many types of input devices can be used.

The correction information may remain stored in the external memory 7 without being loaded on the internal memory 13, and may be referred to as needed. Moreover, when the adjusted coordinates cannot be acquired, a signal indicating that detection is disabled may be returned.

According to the present preferred embodiment, since the input device 17 is used as an input unit of a smartphone and a tablet computer which employs the actual coordinate information acquisition method according to the first embodiment to be optimized for the finger operation, the specific information given to the input device 17 can be output to the display screen 4 easily and accurately.

The present invention can also be carried out in aspects to which various improvements, alterations, and modifications are added based on knowledge of those skilled in the art in the range not departing from the gist of the present invention. Moreover, the present invention may be carried out in forms in which any matters used to specify the invention are replaced with other techniques within the range where the same actions or effects are produced.

For example, the sensor used to switch the display direction of the image in the display screen 4 is not limited to the acceleration sensor 6, but only needs to be a sensor (switching signal output unit) that outputs a signal indicating whether the posture of the display screen 4 is lengthwise or sidewise.

Moreover, for example, the correction information may be values defined in association with each of a plurality of areas that the rectangular coordinate system of the touch panel is divided into (hereinafter, these values will be referred to as correction values). In this case, the areas are identified from the acquired adjusted coordinates. The correction values corresponding to the identified areas are extracted, and the extracted values are added to adjusted values to obtain coordinates that approximate the actual coordinates. Further, a correction table that stores the adjusted coordinates and the correction values in association with each other may be provided in the correction information storage area. In this case, the correction values corresponding to the adjusted coordinates acquired from the system software are extracted, and these extracted correction values are added to the adjustment values to obtain the coordinates that approximate the actual coordinates.

Moreover, the extraction step is not limited to the above-described aspect. For example, the CPU 11 may acquire the posture of the display screen determined by executing the system software and extracting the correction information corresponding to the posture from the correction information storage area 14.

While the first correction information and second correction information are each stored in association with the model number of the portable information terminal, the present invention is not limited to such an embodiment and the first correction information and second correction information may be stored according to the resolution of the touch panel.

There have thus been shown and described a method for acquiring actual coordinates and a method for detecting an input device which fulfill all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A method for acquiring an actual coordinate, comprising:
preparing a portable information terminal that includes a touch panel and system software installed therein to detect actual coordinates of a contact portion in contact with the touch panel and output adjusted coordinates resulting from adjustment of the actual coordinates;
storing correction information defined based on a tendency of the adjustment in a memory of the portable information terminal;
acquiring the output adjusted coordinates;
extracting the correction information from the memory to apply the correction information to the acquired adjusted coordinates; and
acquiring, as the actual coordinates of the contact portion, the adjusted coordinates to which the correction information is applied.

2. The method for acquiring an actual coordinate according to claim 1, wherein
the preparing comprises preparing the portable information terminal including a display screen with the touch panel layered thereon, and a sensor that outputs a sensing signal indicating a posture of the display screen, and the system software that determines the posture of the display screen, based on the sensing signal of the sensor and switches a display direction of an image to the display screen in accordance with the posture of the display screen;
the storing includes storing the correction information in association with the posture of the display screen; and
the extracting includes
acquiring the sensing signal of the sensor,
determining the posture of the display screen, based on the acquired sensing signal, and
extracting the correction information corresponding to the determined posture from the memory.

3. The method for acquiring an actual coordinate according to claim 1, wherein
the preparing comprises preparing the portable information terminal including a display screen with the touch panel layered thereon, and a sensor that outputs a sensing signal indicating a posture of the display screen, and the system software that determines the posture of the display screen, based on the sensing signal of the sensor and switches a display direction of an image to the display screen in accordance with the posture of the display screen;
the storing includes storing the correction information in association with the posture of the display screen; and
the extracting includes
acquiring the determined posture of the display screen, and
extracting the correction information corresponding to the acquired posture of the display screen from the memory.

4. A recording medium in which a program is recorded to instruct a computer, that includes a touch panel and system software installed therein, to detect actual coordinates of a contact portion in contact with the touch panel and output adjusted coordinates resulting from adjustment of the actual coordinates by executing operations of:
storing correction information defined based on a tendency of the adjustment in a memory of the computer;
acquiring the output adjusted coordinates;
extracting the correction information from the memory to apply the correction information to the acquired adjusted coordinates; and
acquiring, as the actual coordinates of the contact portion, the adjusted coordinates to which the correction information is applied.

5. The recording medium according to claim 4, wherein
the storing includes storing the correction information in association with a posture of the display screen; and
the extracting includes
acquiring the sensing signal of the sensor,
determining the posture of the display screen, based on the acquired sensing signal, and
extracting the correction information corresponding to the determined posture from the memory.

6. The recording medium according to claim 4, wherein
the storing includes storing the correction information in association with a posture of the display screen; and
the extracting includes
acquiring the posture of the display screen, and
extracting the correction information corresponding to the acquired posture of the display screen from the memory.

7. A method for detecting an input device for use with a portable information terminal that includes a touch panel and system software installed therein to detect actual coordinates of a plurality of contact portions in contact with the touch panel and output a plurality of adjusted coordinates resulting from adjustment of the respective actual coordinates, and the portable information terminal is configured to detect the input device that has a plurality of contact portions coming into contact with the touch panel and is given specific information, the method comprising:
storing correction information defined based on a tendency of the adjustment in a memory of the portable information terminal, and storing an arrangement pattern of the plurality of contact portions of the input device in the memory;
acquiring the plurality of output adjusted coordinates;
extracting the correction information from the memory to apply the extracted correction information to the plurality of acquired adjusted coordinates;
acquiring, as the actual coordinates of the plurality of contact portions, the plurality of adjusted coordinates to which the correction information is applied; and
reading the arrangement pattern of the plurality of contact portions from the memory to recognize the input device when the arrangement pattern of the plurality of contact portions is consistent with a positional relation of the acquired actual coordinates of the plurality of contact portions.

8. The method according to claim 7, wherein
the storing includes storing the correction information in association with a posture of the display screen; and
the extracting includes
acquiring the sensing signal of the sensor,
determining the posture of the display screen, based on the acquired sensing signal, and
extracting the correction information corresponding to the determined posture from the memory.

9. The method according to claim 7, wherein
the storing includes storing the correction information in association with a posture of the display screen; and
the extracting includes
acquiring the posture of the display screen, and
extracting the correction information corresponding to the acquired posture of the display screen from the memory.
